(19) United States
(12) Patent Application Publication
(10) Pub. No.: US 2009/0082248 A1
(43) Pub. Date: Mar. 26, 2009

(54) Laundry treatment compositions

(76) Inventor: Christopher Clarkson Jones, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/988,693

(22) PCT Filed: May 23, 2006
(86) PCT No.: PCT/EP2006/004894

§ 371 Date: Jan. 11, 2008

(30) Foreign Application Priority Data
Jul. 11, 2005 (GB) 0514147.8

(51) Int. Cl. C11D 3/22; C08B 37/00

(52) U.S. Cl. 510/515; 536/123.1; 536/123.12; 536/56; 536/114

(57) ABSTRACT

A polysaccharide conjugate comprising from 10% to 98%, by weight, of at least one water insoluble fabric care benefit agent which comprises a solid non-silicone fabric lubricant and from 2% to 20%, by weight, of at least one delivery enhancing agent that is a cationic polysaccharide having a backbone comprising β₁₋₄ linkages is useful as a fabric softening agent.

### TECHNICAL FIELD

The present invention relates to the deposition during laundering of non-silicone fabric lubricants, which are solids, for example sugar polyesters, by the use of cationic polysaccharides.

1. Background of the Invention

Compositions which are capable of imparting softening to substrates such as fabric, hair and skin are well known in the art. To date, silicones and related compounds are widely used as softening agents.

However, despite excellent softening properties, silicones have a number of inherent disadvantages, hence the need exists for new softening compounds that do not have the disadvantages of silicones.

In the context of laundry products, the low biodegradable nature of silicone is a notable disadvantage and one which increases in significance as environmental legislation continues to get tougher. Therefore, to find alternatives to silicone which are more biodegradable is a widely sought goal. Another problem often encountered when using silicones as softeners in laundry is that although they increase the soft feel of a fabric they decrease the fabric's absorbency. A decrease in the absorbency properties of a fabric means that its ability to take up water decreases—this is particularly problematic for towels and is strongly disliked by the consumer. Further, cost reduction is an ever present goal across the industry and cheaper alternatives to silicones as softeners are thus sought after.

The improvement of these aspects without a consequential loss in softening capability is clearly desirable.

2. Prior Art

Our UK patent application no GB 0313900.3 discloses compositions comprising a water-soluble or dispersible polysaccharide having a hydrophobic agent bonded thereto by a hydrolytically stable bond and a sugar polyester. The hydrophobic polysaccharide acts as a deposition aid for the sugar polyester.

WO 04/022685 and WO 04/022686 disclose a delivery system for water insoluble fabric care benefit agents, including silicones, dispersible polyolefins and polymer latexes, based on a cationic cellulosic delivery enhancing agent.

There remains a need for further improved deposition systems for the delivery of insoluble non-silicone lubricants such as sugar polyesters having improved biodegradability, that maintain absorbency and reduce costs.

It has now surprisingly been found that compositions comprising a solid non-silicone fabric lubricant which in turn comprises a sugar polyester, and a delivery enhancing agent that is a cationic polysaccharide give benefits of improved biodegradability, lower cost and less hydrophobing without any loss of softening benefit. Improved substantivity for fabric is also obtained by using the solid lubricants.

### DEFINITION OF THE INVENTION

According to a first aspect of the invention, there is provided a polysaccharide conjugate comprising:
a) from 10% to 98%, by weight of the conjugate, of at least one water insoluble fabric care benefit agent comprising a non-silicone fabric lubricant, and
b) from 2% to 20%, by weight of the conjugate, of at least one cationic polysaccharide having a backbone comprising β₁₋₄ linkages,
   wherein the non-silicone fabric lubricant is a solid.

A second aspect of the invention provides a granule comprising the conjugate of the second aspect.

A third aspect of the invention provides a laundry treatment composition comprising the conjugate of the first aspect or the granule of the second aspect.

According to a fourth aspect, there is provided an aqueous wash medium comprising the conjugate as provided by the first aspect of the invention.

According to a fifth aspect of the invention, there is provided a method for depositing a solid sugar polyester onto a substrate, the method comprising contacting, in an aqueous medium, the substrate and a conjugate according to the first aspect of the invention.

A sixth aspect of the invention provides a use of the conjugate according to the first aspect of the invention to provide a softening benefit to a substrate.

Typically, the level of the cationic polysaccharide and non-silicone fabric lubricant conjugate in a fully formulated laundry composition will be from 0.01 to 15 percent (%) by weight of the fully formulated composition.

The aqueous wash medium of the fourth aspect may contain further components, accordant with normal laundry product dosages.

### DETAILED DESCRIPTION OF THE INVENTION

As set out above, the conjugate of the present invention comprises from 10% to 98%, by weight of the conjugate, of at least one water insoluble fabric care benefit agent which comprises a solid non-silicone fabric lubricant and from 2% to 20%, by weight of the conjugate, of at least one delivery enhancing agent that is a cationic polysaccharide with a backbone comprising β₁₋₄ linkages. The conjugate may optionally further comprise from 0.1% to 15% by weight of the conjugate of an anionic, nonionic, cationic or zwitterionic emulsifying surfactant or mixture thereof.

The invention will be described below in respect of various embodiments.

### The Conjugate

The conjugate itself is understood to mean a discrete moiety which is pre-made before addition as part of a laundry formulation.

### The Delivery Enhancing Agent

The conjugate of the present invention comprises from 2% to 20% by weight of the conjugate, of at least one delivery enhancing agent that is a cationic polysaccharide with a backbone comprising β₁₋₄ linkages.

### The Cationic Polysaccharide

The cationic polysaccharide is a β₁₋₄-linked polysaccharide having an affinity for cellulose.

The cationic polysaccharide may be straight or branched. Many naturally occurring polysaccharides have at least some degree of branching, or at any rate at least some saccharide rings are in the form of pendant side groups on a main polysaccharide backbone.

A polysaccharide comprises a plurality of saccharide rings which have pendant hydroxyl groups. In the polysaccharides of the present invention, at least some of these hydroxyl groups may be independently substituted by, or replaced with, one or more other substituents. An example of such a substituent is a hydrophobic agent for example an alkyl chain. The “average degree of substitution” for a given class of substituent means the average number of substituents of that class per saccharide ring for the totality of polysaccharide molecules in the sample and is determined for all saccharide rings.

The cationic polysaccharide preferably has the structure given by the following formula:

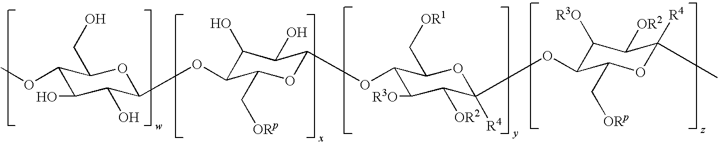

wherein R^{P} is a saccharide ring or oligosaccharide consisting of 2 or 3 saccharide rings, R¹, R², R³ are each independently H, CH₃, C₈₋₂₄ alkyl (linear or branched),

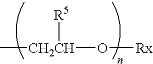

or mixtures thereof; wherein n is from 1 to 10; Rx is H, CH₃, C₈₋₂₄ alkyl (linear or branched),

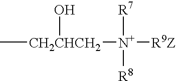

or mixtures thereof, wherein Z is a chlorine ion, bromine ion, or mixture thereof; R⁵ is H, CH₃, CH₂CH₃, or mixtures thereof; R⁷ is CH₃, CH₂CH₃, a phenyl group, a C₈₋₂₄ alkyl group (linear or branched), or mixture thereof; and R⁸ and R⁹ are each independently CH₃, CH₂CH₃, phenyl, or mixtures thereof: R⁴ is H,

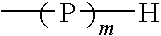

or mixtures thereof wherein P is a repeat unit of an

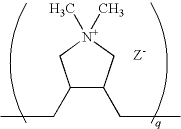

addition polymer formed by radical polymerization of a cationic monomer,
wherein Z′ is a chlorine ion, bromine ion or mixtures thereof and q is from 1 to 10,
such that at least one of R¹, R², R³ or R⁴ is cationic.

A preferred group of polysaccharides (locust bean gum, for example) have pendant galactose or other sugar residues which make them effectively more water dispersible/soluble than the unmodified polysaccharide backbone, but which are not hydrolysed from the backbone under conditions of use.

The polysaccharide has a backbone comprising β₁₋₄ linkages. More preferably it has a backbone that is poly-glucan, poly-mannan, or gluco-mannan or mixtures thereof and most preferably the polysaccharide is a galacto-mannan or xylo-glucan or mixtures thereof. A particularly preferred group of polysaccharides is Cellulose, Locust Bean Gum, Tara Gum, Tamarind xyloglucan, and guar gum or mixtures thereof.

### The Water Insoluble Fabric Care Benefit Agent

The present invention comprises from 10% to 98%, by weight of the conjugate, of at least one water insoluble fabric care benefit agent which comprises a solid non-silicone fabric lubricant.

As used herein, the term “solid non-silicone fabric lubricant” is taken to mean a non-silicone fabric lubricant which exists as a solid or substantially solid material at ambient temperature and pressure. For sake of clarity it is intended to include materials such as waxes and highly viscous-liquids which are solid or substantially solid at ambient temperatures and pressures. Preferably, the solid non-silicone fabric lubricants of the present invention have a melting point of 25 degrees C. or higher.

### The Non-Silicone Fabric Lubricant

The preferred water insoluble fabric lubricant for use in the invention is a solid sugar polyester (SPE).

The solid sugar polyester is preferably selected from the group consisting of sucrose polyesters, glucose polyesters and cellobiose polyesters, and is most preferably a sucrose polyester.

The preferred sucrose polyesters for use in the conjugates of the present invention have 2 to 4 hydrocarbon chains per sugar ring, where the hydrocarbon chain is fully saturated and has a length of from 12 to 22 carbon atoms. The most preferred sucrose polyesters are stearate and palmitate sugar polyesters having 2 hydrophobic chains per sugar ring (i.e. having saturated C18 and C16 hydrocarbon chains respectively).

An example of a commercially available preferred sucrose polyester is Ryoto Sugar Ester S270 supplied by Mitsubishi Kagaku Foods Corporation, which is a sucrose polystearate with an average DS about 4 but according to the manufacturer's specification contains distearate, monostearate, tristearate, tetrastearate, pentastearate and hexastearate and has a HLB value of 2.

It should be noted that these sucrose polyesters normally contain a spread of degree of substitution on the saccharide rings, for example, sucrose tetrastearate also comprises tristearate, pentastearate, hexastearate, etc. It should also be noted that a spread of fatty chain lengths may also exist: for example in S270, according to the manufacturer, only 70% of the fatty chains are actually stearate. Furthermore, the sugar polyesters may contain traces of surfactant which is separate from the optional surfactants according to the invention.

Deposition of the non-silicone fabric lubricant onto a substrate includes deposition by adsorption, co-crystallisation, entrapment and/or adhesion.

The non-silicone fabric lubricant may or may not be chemically bonded to the polysaccharide. Preferably, the non-silicone fabric lubricant is not chemically bonded to the polysaccharide. In a further embodiment, some of the non-silicone fabric lubricant is chemically bonded to the polysaccharide, whilst some is not.

By chemically bonded is meant the non-silicone fabric lubricant is attached by a chemical bond (such as a covalent bond or an ionic bond) to the polysaccharide.

That non-silicone fabric lubricant which is not chemically bonded to the polysaccharide may be bonded thereto by a physical bond (such as hydrogen bonds, van der waal forces, hydrophobic interactions, electrostatic interactions, etc).

In the embodiment of the invention, where some non-silicone fabric lubricant is bonded to the polysaccharide by a chemical bond and some is not, the ratio of non-silicone fabric lubricant which is bonded to the polysaccharide by a chemical bond to that non-silicone fabric lubricant which is not bonded by a chemical bond is in the range of from 1:1000 to 1:1 and preferably from 1:200 to 1:4.

### The Optional Hydrophobic Agent

The polysaccharide part of the conjugate of the invention may optionally comprise a hydrophobic agent bonded thereto.

The optional hydrophobic agent is one that renders the material more surface active than the polysaccharide alone.

By surface active is meant that the material tends to accumulate at oil/water interfaces and lower their surface tension.

The hydrophobicity should not be so great as to prevent the dissolution or dispersion of the polysaccharide in water.

The hydrophobic agent is preferably selected from the group consisting of hydrocarbon and hydrophobic polymer.

The hydrophobic agent is attached to the polysaccharide by a stable bond. That means that the bonding of the hydrophobic agent should be sufficiently stable so as not to undergo hydrolysis during processing or on storage prior to use or in the environment of the treatment process for the duration of that process. For example, in laundry cleaning applications, the bond between the hydrophobic agent and polysaccharide should be sufficiently stable so that it does not undergo hydrolysis in the wash liquor, at the wash temperature, before the non-silicone fabric lubricant has been deposited onto the fabric.

Preferably, the bond between the hydrophobic agent and the polysaccharide is such that the decay rate constant (k_{d}) of the material in an aqueous solution at 0.01 wt % of the material together with 0.1 wt % of anionic surfactant at a temperature of 40° C. at a pH of 10.5 is such that k_{d}<10⁻³ s⁻¹.

The conjugate may comprise an emulsifying agent.

The emulsifying agent is especially one or more surfactants, for example, selected from any class, sub class or specific surfactant(s) disclosed herein in any context.

The emulsifying agent most preferably comprises or consists of a nonionic surfactant. Additionally or alternatively, one or more selected additional surfactants from anionic, cationic, zwitterionic and amphoteric surfactants may be incorporated in or used as the emulsifying agent.

The conjugate of the invention may further comprise from 1% to 30% by weight of the conjugate of an anionic or nonionic cleaning surfactant or mixture thereof.

Suitable nonionic surfactants include the (poly)-alkoxylated analogues of saturated or unsaturated fatty alcohols, for example, having from 8 to 22, preferably from 9 to 18, more preferably from 10 to 15 carbon atoms on average in the hydrocarbon chain thereof and preferably on average from 3 to 11, more preferably from 4 to 9 alkyleneoxy groups. Most preferably, the alkyleneoxy groups are independently selected from ethyleneoxy, propyleneoxy and butylenoxy, especially ethyleneoxy and propylenoxy, or solely ethyleneoxy groups and alkyl polyglucosides as disclosed in EP 0 495 176.

Preferably, the (poly)alkoxylated analogues of saturated or unsaturated fatty alcohols, have a hydrophilic-lipophilic balance (HLB) of between 8 to 18.

The HLB of a polyethoxylated primary alcohol nonionic surfactant can be calculated by

$$H L B = \frac{M W ( EO )}{M W ( TOT ) \times 5} \times 100$$

where
MW (EO)=the molecular weight of the hydrophilic part (based on the average number of EO groups).
MW(TOT)=the molecular weight of the whole surfactant (based on the average chain length of the hydrocarbon chain).

This is the classical HLB calculation according to Griffin (J. Soc. Cosmetic Chemists, 5 (1954) 249-256).

For analogous nonionics with a mix of ethyleneoxy (EO), propylenoxy (PO) and/or butyleneoxy (BO) hydrophilic groups, the following formula can be used;

$$H L B = \frac{M W ( EO ) + 0.57 M W ( PO ) + 0.4 M W ( BO )}{M W ( TOT ) \times 5}$$

Preferably, the alkyl polyglucosides may have the following formula;

R—O—Zₙ

in which R is a linear or branched, saturated or unsaturated aliphatic alkyl radical having 8 to 18 carbon atoms or mixtures thereof, and Zₙ is a polyglycosyl radical with n=1.0 to 1.4 hexose or pentose units or mixtures. Preferred examples of alkylpolyglucosides include Glucopon™.

The conjugate of the invention may be incorporated by admixture with other components of a laundry treatment composition.

The conjugate is prepared by heating the solid non-silicone lubricant above its melting point, adding the molten non-silicone lubricant to a hot solution of the cationic polysaccharide, other liquid component (e.g. water) and preferably also an emulsifying agent, such as a surfactant, especially a nonionic surfactant. This hot mixture is then subjected to vigorous agitation e.g. in a high shear mixture to form a stable, hot emulsion. The emulsion is then cooled to below the melting point of the solid non-silicone lubricant and optionally, the water is removed e.g. by spray drying.

### Laundry Treatment Compositions

The conjugate of the invention is preferably incorporated into laundry compositions as an ingredient to be incorporated in the laundry treatment composition. Such a composition may optionally also comprise only a diluent (which may comprise solid and/or liquid) and/or also it may comprise an active ingredient.

The conjugate of the invention is typically included in said laundry compositions at levels of from 0.001% to 10%, preferably from 0.005% to 5%, most preferably from 0.01% to 3% by weight of the total laundry composition.

If an emulsion is employed, typical inclusion levels of the emulsion in the laundry treatment composition are from 0.01% to 40%, more preferably from 0.001% to 30%, even more preferably from 0.1% to 20%, especially from 1% to 10% by weight of the total composition.

The compositions of the invention may be in any suitable physical form e.g. a solid such as a powder or granules, a tablet, a solid bar, a paste, gel or liquid, especially, an aqueous based liquid. In particular the compositions may be used in laundry compositions, especially in liquid, powder or tablet laundry composition.

The conjugates of the present invention may be contained in main wash (fabric washing) laundry compositions. Conjugates according to the invention may contain at least one further component, for example a fabric softening agent which may be the same as but which is separate from the water insoluble fabric care benefit agent which forms part of the conjugate of the invention.

The compositions of the invention may contain a surface-active compound (surfactant) which may be chosen from soap and non-soap anionic, cationic, nonionic, amphoteric and zwitterionic surface-active compounds and mixtures thereof. Many suitable surface-active compounds are available and are fully described in the literature, for example, in “Surface-Active Agents and Detergents”, Volumes I and II, by Schwartz, Perry and Berch. These surface-active compounds may be the same as but are separate from the emulsifying surfactant which optionally forms part of the conjugate of the invention.

The preferred detergent-active compounds that can be used are soaps and synthetic non-soap anionic and nonionic compounds.

The compositions of the invention may contain linear alkylbenzene sulphonate, particularly linear alkylbenzene sulphonates having an alkyl chain length of C₈-C₁₅. It is preferred if the level of linear alkylbenzene sulphonate is from 0 wt % to 30 wt %, more preferably 1 wt % to 25 wt %, most preferably from 2 wt % to 15 wt %, by weight of the total composition.

The compositions of the invention may contain other anionic surfactants in amounts additional to the percentages quoted above. Suitable anionic surfactants are well-known to those skilled in the art. Examples include primary and secondary alkyl sulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred. These anionic surfactants may be the same as but are separate from the emulsifying surfactant which optionally forms part of the conjugates of the invention.

The compositions of the invention may optionally also contain nonionic surfactant. For the sake of clarity, this non-ionic surfactant may be the same as but is separate from the nonionic surfactant which may be present as the emulsifying agent where the conjugate of the invention is in the form of an emulsion. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl-polyglycosides, glycerol monoethers, and polyhydroxyamides (glucamide).

It is preferred if the level of nonionic surfactant is from 0 wt % to 30 wt %, preferably from 1 wt % to 25 wt %, most preferably from 2 wt % to 15 wt %, by weight of the total composition.

The choice of surface-active compound (surfactant), and the amount present, will depend on the intended use of the detergent composition. In fabric washing compositions, different surfactant systems may be chosen, as is well known to the skilled formulator, for hand-washing products and for products intended for use in different types of washing machine.

The total amount of surfactant present will also depend on the intended end use and may be as high as 60 wt %, for example, in a composition for washing fabrics by hand. In compositions for machine washing of fabrics, an amount of from 5 to 40% by weight of the total composition is generally appropriate. Typically the compositions will comprise at least 2% surfactant e.g. from 2 to 60%, preferably from 15 to 40% most preferably from 25 to 35% by weight of the total composition.

Detergent compositions suitable for use in most automatic fabric washing machines generally contain anionic non-soap surfactant, or nonionic surfactant, or combinations of the two in any suitable ratio, optionally together with soap.

The laundry compositions of the invention, will generally also contain one or more detergency builders. The total amount of detergency builder in the compositions will typically range from 5 to 80 wt %, preferably from 10 to 60 wt % based on the total composition.

Inorganic builders that may be present include sodium carbonate, if desired in combination with a crystallisation seed for calcium carbonate, as disclosed in GB 1 437 950 (Unilever); crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164 514B (Hoechst). Inorganic phosphate builders, for example, sodium orthophosphate, pyrophosphate and tripolyphosphate are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50 wt %.

The alkali metal aluminosilicate may be either crystalline or amorphous or mixtures thereof, having the general formula: 0.8-1.5 Na₂O. Al₂O₃. 0.8-6 SiO₂

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium weight ratio not exceeding 1.33, preferably within the range of from 0.90 to 1.33, and more preferably within the range of from 0.90 to 1.20.

Especially preferred is zeolite MAP having a silicon to aluminium weight ratio not exceeding 1.07, more preferably about 1.00. The calcium binding capacity of zeolite MAP is generally at least 150 mg CaO per g of anhydrous material.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di and trisuccinates, carboxymethyloxy succinates, carboxymethyloxymalonates, dipicolinates, hydroxyethyliminodiacetates, alkyl- and alkenylmalonates and succinates; and sulphonated fatty acid salts. This list is not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %.

Builders, both inorganic and organic, are preferably present in alkali metal salt, especially sodium salt, form.

Compositions according to the invention may also suitably contain a bleach system. Fabric washing compositions may desirably contain peroxy bleach compounds, for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate.

Especially preferred is sodium percarbonate having a protective coating against destabilisation by moisture. Sodium percarbonate having a protective coating comprising sodium metaborate and sodium silicate is disclosed in GB 2 123 044B (Kao).

The peroxy bleach compound is suitably present in an amount of from 0.1 to 35 wt %, preferably from 0.5 to 25 wt %. The peroxy bleach compound may be used in conjunction with a bleach activator (bleach precursor) to improve bleaching action at low wash temperatures. The bleach precursor is suitably present in an amount of from 0.1 to 8 wt %, preferably from 0.5 to 5 wt %.

Preferred bleach precursors are peroxycarboxylic acid precursors, more especially peracetic acid precursors and pernoanoic acid precursors. Especially preferred bleach precursors suitable for use in the present invention are N,N,N′,N′,-tetracetyl ethylenediamine (TAED) and sodium nonanoyloxybenzene sulphonate (SNOBS). The novel quaternary ammonium and phosphonium bleach precursors disclosed in U.S. Pat. No. 4,751,015 and U.S. Pat. No. 4,818,426 (Lever Brothers Company) and EP 402 971A (Unilever), and the cationic bleach precursors disclosed in EP 284 292A and EP 303 520A (Kao) are also of interest.

The bleach system can be either supplemented with or replaced by a peroxyacid. Examples of such peracids can be found in U.S. Pat. No. 4,686,063 and U.S. Pat. No. 5,397,501 (Unilever). A preferred example is the imido peroxycarboxylic class of peracids described in EP A 325 288, EP A 349 940, DE 382 3172 and EP 325 289. A particularly preferred example is phthalimido peroxy caproic acid (PAP). Such peracids are suitably present at 0.1-12%, preferably 0.5-10%.

A bleach stabiliser (transition metal sequestrant) may also be present. Suitable bleach stabilisers include ethylenediamine tetra-acetate (EDTA), the polyphosphonates such as Dequest (Trade Mark) and non-phosphate stabilisers such as EDDS (ethylene diamine di-succinic acid). These bleach stabilisers are also useful for stain removal especially in products containing low levels of bleaching species or no bleaching species.

An especially preferred bleach system comprises a peroxy bleach compound (preferably sodium percarbonate optionally together with a bleach activator), and a transition metal bleach catalyst as described and claimed in EP 458 397A, EP 458 398A and EP 509 787A (Unilever).

Bleach systems may comprise transition metal catalyst systems such as those disclosed in WO9965905; WO0012667; WO0012808; WO0029537, and, WO0060045. These catalyst systems have the advantage that they require no added peroxyl compounds and can work, directly or indirectly, using atmospheric oxygen.

The compositions according to the invention may also contain one or more enzyme(s). Suitable enzymes include the proteases, amylases, cellulases, oxidases, peroxidases and lipases usable for incorporation in detergent compositions.

Preferred proteolytic enzymes (proteases) are, catalytically active protein materials which degrade or alter protein types of stains when present as in fabric stains in a hydrolysis reaction. They may be of any suitable origin, such as vegetable, animal, bacterial or yeast origin.

Proteolytic enzymes or proteases of various qualities and origins and having activity in various pH ranges of from 4-12 are available and can be used in the instant invention. Examples of suitable proteolytic enzymes are the subtilisins which are obtained from particular strains of B. subtilis B. licheniformis, such as the commercially available subtilisins Maxatase (Trade Mark), as supplied by Genencor International N.V., Delft, Holland, and Alcalase™, as supplied by Novozymes Industri A/S, Copenhagen, Denmark.

Particularly suitable is a protease obtained from a strain of Bacillus having maximum activity throughout the pH range of 8-12, being commercially available, e.g. from Novozymes Industri A/S under the registered trade-names Esperase™ and Savinase™. The preparation of these and analogous enzymes is described in GB 1 243 785. Other commercial proteases are Kazusase (Trade Mark obtainable from Showa-Denko of Japan), Optimase (Trade Mark from Miles Kali-Chemie, Hannover, West Germany), and Superase (Trade Mark obtainable from Pfizer of U.S.A.).

Detergency enzymes are commonly employed in granular form in amounts of from about 0.1 to about 3.0 wt %. However, any suitable physical form of enzyme may be used.

The combination of non-cellulose polysaccharides and cellulase enzymes is particularly useful, as these enzymes exhibit reduced activity against this class of polysaccharides, as compared to their activity against cellulose. Cellulase is known to be useful and is used in laundry products for de-fuzzing and colour brightening.

The compositions of the invention may contain alkali metal (preferably sodium) carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Powder flow may be improved by the incorporation of a small amount of a powder structurant, for example, a fatty acid (or fatty acid soap), a sugar, an acrylate or acrylate/maleate copolymer, or sodium silicate. One preferred powder structurant is fatty acid soap, suitably present in an amount of from 1 to 5 wt %.

Other materials that may be present in detergent compositions of the invention include sodium silicate; anti-redeposition agents such as cellulosic polymers; soil release polymers; inorganic salts such as sodium sulphate; or lather boosters as appropriate; dyes; coloured speckles; fluorescers and de-coupling polymers. This list is not intended to be exhaustive. However, many of these ingredients will be better delivered as benefit agent groups in materials according to the first aspect of the invention.

The detergent composition when diluted in the wash liquor (during a typical wash cycle) will typically give a pH of the wash liquor from 7 to 10.5 for a main wash detergent.

Particulate detergent compositions are suitably prepared by spray-drying a slurry of compatible heat-insensitive ingredients, and then spraying on or post-dosing those ingredients unsuitable for processing via the slurry. The skilled detergent formulator will have no difficulty in deciding which ingredients should be included in the slurry and which should not.

Particulate detergent compositions of the invention preferably have a bulk density of at least 400 g/l, more preferably at least 500 g/l. Especially preferred compositions have bulk densities of at least 650 g/litre, more preferably at least 700 g/litre.

Such powders may be prepared either by post-tower densification of spray-dried powder, or by wholly non-tower methods such as dry mixing and granulation; in both cases a high-speed mixer/granulator may advantageously be used. Processes using high-speed mixer/granulators are disclosed, for example, in EP 340 013A, EP 367 339A, EP 390 251A and EP 420 317A (Unilever).

Liquid detergent compositions can be prepared by admixing the essential and optional ingredients thereof in any desired order to provide compositions containing components in the requisite concentrations. Liquid compositions according to the present invention can also be in compact form which means it will contain a lower level of water compared to a conventional liquid detergent.

### Product Forms

Product forms include powders, liquids, gels, tablets, any of which are optionally incorporated in a water-soluble or water dispersible sachet. The means for manufacturing any of the product forms are well known in the art. If the composition of the invention is to be incorporated in a powder (optionally the powder to be tableted), and whether or not pre-emulsified, it is optionally included in a separate granular component, e.g. also containing a water soluble organic or inorganic material, or in encapsulated form.

### Substrate

The substrate may be any substrate onto which it is desirable to deposit non-silicone fabric lubricant and which is subjected to treatment such as a washing or rinsing process.

In particular, the substrate may be a textile fabric. It has been found that particular good results are achieved when using a natural fabric substrate such as cotton, or fabric blends containing cotton.

### Treatment

The treatment of the substrate with the material of the invention can be made by any suitable method such as washing, soaking or rinsing of the substrate.

Typically the treatment will involve a washing or rinsing method such as treatment in the main wash or rinse cycle of a washing machine and involves contacting the substrate with an aqueous medium comprising the conjugate of the invention.

The aqueous medium may contain further components, accordant with normal laundry product dosages.

### EXAMPLES

Embodiments of the present invention will now be explained in more detail by reference to the following non-limiting examples.

In the following examples where percentages are mentioned, this is to be understood as percentage by weight. In the following tables where the values do not add up to 100 these are to be understood as parts by weight.

Although individual weights are given for the polysaccharide part and the non-silicone lubricant part of the conjugate when present in fully formulated products, it is understood that these are the weight amount of material that the conjugate was prepared from. It is the pre-made discrete conjugate itself that is included in the exemplified formulations.

### Example A

### Preparation of the Polysaccharide Conjugate

Jaguar C 14 S (ex Rhodia, 0.1 g) was weighed into a bottle along with 10 cm³ of water. This mixture was heated to 70° C. and then agitated using an ultrasonic probe (Soniprobe™) at half power until no undissolved polymer was visible (2-3 minutes). Ryoto Sugar Ester S270 (ex Mitsubishi Kagaku, 5 g) was gently heated at 70° C. until molten. The melt was then added to the hot solution. The mixture was further agitated with the ultrasonic probe (1 minute at setting 6 followed by 2×1 minute at setting 8) to produce an emulsion. The emulsion was then allowed to cool to room temperature to yield a dispersion of solid particles of the polysaccharide conjugate dispersed in an aqueous solution.

### Example B

### Preparation of Polysaccharide Complex Using Co-Emulsifier

Celquat H-100 (ex National Starch, 0.5 g) and Dobanol 25-7 (ex Shell, 0.15 g) was weighed into a wide-necked bottle along with 50 g of water. This mixture was heated to 70° C. and agitated using an ultrasonic probe (Soniprobe™) at half power until no undissolved material was visible (3×1 minute periods). Ryoto Sugar Ester S270 (ex Mitsubishi Kagaku, 5 g) was gently heated at 70° C. until molten. The melt was then added to the hot solution. The mixture was sheared using a Silverson™ L4R high shear mixer fitted with a 25 mm diameter shearing head and a square-hole, high shear screen. The mixer was set at full speed (˜6000 rpm) for five minutes at 70° C. to produce an emulsion. The emulsion was then allowed to cool to room temperature to yield a dispersion consisting of particles of the solid polysaccharide conjugate dispersed in an aqueous solution.

### Example 1

### Spray-Dried Powder

| Component | % w/w |
|---|---|
| Na PAS | 11.5 |
| Dobanol 25-7 | 6.3 |
| Soap | 2.0 |
| Zeolite | 24.1 |
| Na Citrate | 10.6 |
| Na Carbonate | 23.0 |
| Dequest 2066 | 0.4 |
| Sokalan CP5 | 0.9 |
| Savinase 16L | 0.7 |
| Lipolase | 0.1 |
| Perfume | 0.4 |
| Cationic cellulose * | 0.25 |
| sucrose polyester † | 2.5 |
| Water/salts | to 100 |

* is Celquat H-100 supplied by National Starch
† is Ryoto Sugar Ester S270 supplied by Mitsubishi Kagaku Foods Corporation.

The sucrose polyester and cationic cellulose were made into a discrete pre-made conjugate as described earlier, and it was this that was added as an ingredient in the full formulation. So for this example, a conjugate containing 2.5 g of sucrose polyester and 0.25 g of cationic cellulose was prepared and subsequently added as an ingredient to the formulation.

### Example 2

### Detergent Granulate Prepared by Non-Spray Drying Method

The following composition was prepared by the two-stage mechanical granulation method described in EP-A-367 339.

| Component | % w/w |
|---|---|
| NaPAS | 16.6 |
| Dobanol 25-7 | 3.1 |
| STPP | 49.7 |
| Na Carbonate | 5.0 |
| cationic polysaccharide * | 0.4 |
| sugar polyester † | 4.0 |
| Na Silicate | 12.4 |
| Minors | 2.0 |
| Water | balance |

* is Polymer JR-30 supplied by Amerchol
† is Ryoto Sugar Ester S170 supplied by Mitsubishi Kagaku Foods Corporation

The sucrose polyester and cationic cellulose were made into a discrete pre-made conjugate as described earlier, and it was this that was added as an ingredient in the full formulation.

So for this example, a conjugate containing 4 g of sucrose polyester and 0.4 g of cationic polysaccharide was prepared and subsequently added as an ingredient to the formulation.

### Example 3

### Isotropic Laundry Liquid

| Component | % w/w |
|---|---|
| Na-citrate (37.5%) | 10.7 |
| Propyleneglycol | 7.5 |
| Ethylene Glycol | 4.5 |
| Borax | 3.0 |
| Savinase 16L | 0.3 |
| Lipolase | 0.1 |
| cationic guar gum* | 0.25 |
| sucrose polyester# | 5.0 |
| Monoethanolamine | 0.5 |
| Cocofatty acid | 1.7 |
| NaOH (50%) | 2.2 |
| LAS | 10.3 |
| Dobanol 25-7 | 6.3 |
| LES | 7.6 |
| Minors | 1.3 |
| (adjust pH to 7 with NaOH) | |
| Water | up to 100 |

*is Jaguar C 14 S supplied Rhodia
#is Ryoto Sugar Ester S270 supplied by Mitsubishi Kagaku Foods Corporation

The sucrose polyester and cationic cellulose were made into a discrete pre-made conjugate as described earlier, and it was this that was added as an ingredient in the full formulation. So for this example, a conjugate containing 5 g of sucrose polyester and 0.25 g of cationic guar gum was prepared and subsequently added as an ingredient to the formulation.

### Example 4

### Structured Laundry Liquid

| Component | % w/w |
|---|---|
| LAS | 16.5 |
| Dobanol 25-7 | 9.0 |
| Oleic acid (Priolene 6907) | 4.5 |
| Zeolite | 15.0 |
| KOH, neutralisation of acids and pH | to 8.5 |
| Citric acid | 8.2 |
| deflocculating polymer | 1.0 |
| Protease | 0.38 |
| Lipolase | 0.2 |
| cationic guar* | 0.15 |
| sucrose polyester# | 2.0 |
| Minors | 0.4 |
| Water | to 100% |

*is Jaguar C 14 S supplied Rhodia
#is Ryoto Sugar Ester S270 supplied by Mitsubishi Kagaku Foods Corporation

The sucrose polyester and cationic cellulose were made into a discrete pre-made conjugate as described earlier, and it was this that was added as an ingredient in the full formulation. So for this example, a conjugate containing 2 g of sucrose polyester and 0.15 g of cationic guar was prepared and subsequently added as an ingredient to the formulation.

### Raw Material Specification

| Component | Specification |
|---|---|
| LAS | Linear Alkyl Benzene Sulphonic-acid, Marlon |
| | AS3, ex Huls |
| Na-LAS | LAS-acid neutralised with NaOH |
| Dobanol 25-7 | C12-15 ethoxylated alcohol, 7EO, ex Shell |
| LES | Lauryl Ether Sulphate, Dobanol 25-S3, ex Shell |
| Zeolite | Wessalith P, ex Degussa |
| STPP | Sodium Tri PolyPhosphate, Thermphos NW, ex |
| | Hoechst |
| Dequest 2066 | Metal chelating agent, ex Monsanto |
| Silicone oil | Antifoam, DB 100, ex Dow Corning |
| Tinopal CBS-X | Fluorescer, ex Ciba-Geigy |
| Lipolase | Type 100L, ex Novo |
| Savinase 16L | Protease, ex Novo |
| Sokalan CP5 | Acrylic/Meleic Builder Polymer ex BASF |
| Deflocculating Polymer | Polymer A-11 disclosed in EP-A-346 995 |
| SCMC | Sodium Carboxymethyl Cellulose |
| Minors | antiredeposition polymers, transition-metal |
| | scavangers/bleach stabilisers, fluorescers, |
| | antifoams, dye-transfer-inhibition polymers, |
| | enzymes, and perfume. |

1. A discrete polysaccharide conjugate comprising:
a) from 10% to 98%, by weight of the conjugate, of at least one water insoluble fabric care benefit agent comprising a non-silicone fabric lubricant, and
b) from 2% to 20%, by weight of the conjugate, of at least one cationic polysaccharide having a backbone comprising 1-4 linkages,
wherein the non-silicone fabric lubricant is a solid.

2. A conjugate as claimed in claim 1 wherein the polysaccharide has a hydrophobic agent bonded thereto.

3. A conjugate as claimed in claim 2 wherein the hydrophobic agent is selected from the group consisting of hydrocarbon and hydrophobic polymer.

4. A conjugate as claimed in claim 1 further comprising from 0.1 to 15% by weight of the conjugate of an anionic, non-ionic, cationic or zwitteronic emulsifying surfactant or mixture thereof.

5. A conjugate as claimed in claim 4 wherein the emulsifying surfactant comprises a nonionic surfactant.

6. A conjugate according to claim 1 wherein the cationic polysaccharide has the structure: 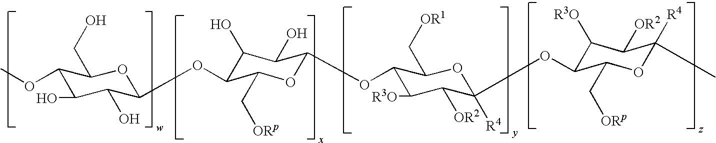
wherein R^{P} is a saccharide ring or oligosaccharide consisting of 2 or 3 saccharide rings,
R¹, R², R³ are each independently H, CH₃, C₈₋₂₄ alkyl (linear or branched), 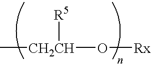
or mixtures thereof; wherein n is from 1 to 10; Rx is H, CH₃, C₈₋₂₄ alkyl (linear or branched), 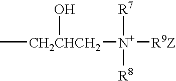
or mixtures thereof, wherein Z is a chlorine ion, bromine ion, or mixture thereof; R⁵ is H, CH₃, CH₂CH₃, or mixtures thereof; R⁷ is CH₃, CH₂CH₃, a phenyl group, a C₈₋₂₄ alkyl group (linear or branched), or mixture thereof; and R⁸ and R⁹ are each independently CH₃, CH₂CH₃, phenyl, or mixtures thereof: R⁴ is H, 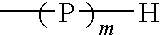
or mixtures thereof wherein P is a repeat unit of an addition polymer formed by radical polymerization of a cationic monomer 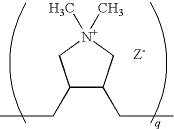
wherein Z′ is a chlorine ion, bromine ion or mixtures thereof and q is from 1 to 10, such that at least one of R¹, R², R³ is cationic and wherein the indices w, x, y and z are such that their sum, n, has an average of from 6 to about 10000 and the sum of x and z has a value of zero or from about n/8 to about n/2 and the sum of y and z is greater than zero.

7. A conjugate according to claim 1 wherein the polysaccharide backbone is a poly-glucan, poly-mannan, gluco-mannan or a mixture thereof.

8. A conjugate according to claim 7 wherein the polysaccharide is a galacto-mannan, xylo-glucan or a mixture thereof.

9. A conjugate according to claim 8 wherein the polysaccharide is cellulose, locust bean gum, Tara Gum, tamarind xyloglucan, guar gum or mixture thereof.

10. A conjugate according to claim 1 wherein the non-silicone fabric lubricant is a solid sugar polyester.

11. A conjugate according to claim 10 wherein the solid sugar polyester is selected from the group consisting of sucrose polyesters, glucose polyesters and cellobiose polyesters.

12. A conjugate according to claim 11 wherein the sugar polyester is a sucrose polyester.

13. A conjugate according to claim 12 wherein the sucrose polyester has 2 to 4 hydrocarbon chains per sugar ring, and wherein the hydrocarbon chain is fully saturated and has a length of from 12 to 22 carbon atoms.

14. A conjugate according to claim 12 wherein the sucrose polyester is selected from stearate and palmitate sugar polyesters having 2 hydrophobic chains per sugar ring.

15. A conjugate according to claim 1 wherein some of the non-silicone fabric lubricant is bonded to the polysaccharide by a chemical bond.

16. A conjugate as claimed in claim 1 comprising at least one further component.

17. A granule comprising the conjugate as claimed in claim 1.

18. A main wash laundry composition comprising a conjugate as claimed in claim 1.

19. A main wash laundry composition comprising a granule as claimed in claim 17.

20. An aqueous main wash liquor having a pH of from 7 to 10.5, comprising a main wash laundry composition as claimed in claim 18.

21. A method for depositing a solid sugar polyester onto a substrate, the method comprising, contacting in an aqueous main wash liquor, the substrate and a conjugate according to claim 1.

22. Use of a conjugate as claimed in claim 1 to provide a softening benefit to a substrate.
